(19) United States
(12) Patent Application Publication
(10) Pub. No.: US 2026/0145354 A1
(43) Pub. Date: May 28, 2026

(54) CUTTING TOOL HEAD ANGLE ADJUSTMENT MECHANISM

(71) Applicants: Ningbo Xiecheng Power Tools Co., Ltd, Ningbo (CN); Ningbo Colet Electrical APPLIANCE Co., Ltd, Ningbo (CN)

(72) Inventors: Bowen Duan, Ningbo (CN); Bing Wu, Ningbo (CN); Guangcun Wang, Ningbo (CN); Li Wang, Ningbo (CN)

(21) Appl. No.: 18/991,768

(22) Filed: Dec. 23, 2024

(30) Foreign Application Priority Data
Nov. 22, 2024 (CN) 2024116777042

(51) Int. Cl. B26D 7/26

(52) U.S. Cl. CPC B26D 7/2635

(57) ABSTRACT

A cutting tool head angle adjustment mechanism comprising a base, a head connected to a support seat and a locking disc; the head is internally provided with an accommodating hole for allowing a locking pin to extend and retract; an elastic member is arranged in the accommodating hole; when the locking switch swings back and forth, the locking block is propelled to reciprocate between the position of clamping the locking disc and the position of releasing the locking disc, so that locking and unlocking between the head and the support seat at any angle are achieved; when the locking pin reciprocates between the position of inserting into the locking hole and the position of escaping the locking hole, the automatic locking and unlocking between the head and the support seat at a specific angle are achieved; the head angle adjustment mechanism achieves convenient and fast operation and ideal locking effect.

### TECHNICAL FIELD

This invention generally relates to the technical field of cutting tools, and more particularly, to a cutting tool head angle adjustment mechanism.

### BACKGROUND

A miter saw mainly depends on a saw blade rotating at a high speed to effectively cut various materials, such as metal, wood and plastic, etc. The inclined design of the saw blade enables the saw dust generated in the cutting process to be smoothly discharged, thereby ensuring the cutting efficiency and quality. The miter saw is a type of table tool, capable of perform a cutting operation at a certain inclination angle. It normally comprises a cutting device capable of rotating and inclining and a worktable capable of rotating.

A conventional miter saw comprises a base, a worktable arranged on the base, and a cutting device located above the worktable. A rear end of the worktable is provided with a support seat. The cutting device comprises a head swingably connected to the support seat, a guide rail assembly slidably arranged on the head, a connecting member connected to a front end of the guide rail assembly, and a cutting assembly pivotally connected to the connecting member. The head of the cutting device needs to be locked after swinging relative to the support seat. In the prior art, the head locking structure of the cutting device is complex, and the locking mode is single, resulting in a poor use experience.

### SUMMARY

The purpose of the present invention is to provide a cutting tool head angle adjustment mechanism, which is capable of adjusting the head at a specific angle or any angle by means of the same locking switch. According to the present invention, convenient and fast operation as well as ideal locking effect are achieved.

To achieve the above purpose, the present invention adopts the following technical solution: a cutting tool head angle adjustment mechanism comprises a support seat arranged at the rear end of the worktable, a head swingably connected to the support seat and a locking disc arranged between the head and the support seat; the locking disc is fixedly connected to the support seat; the head angle adjustment mechanism further comprises a locking block, a locking pin, a transmission mechanism, a linkage mechanism, and a locking switch; the locking disc is provided with a plurality of locking holes arranged at intervals and having a specific angle; the locking holes are arranged in the swinging path of the locking pin; the head is internally provided with an accommodating hole for allowing the locking pin to extend and retract; the accommodating hole is internally provided with an elastic member for propelling the locking pin to move in the direction of inserting into the locking hole; a rear end of the locking pin is in linkage with the transmission mechanism by means of the linkage mechanism; the locking switch is in transmission connection with the locking block by means of the transmission mechanism; when the locking switch swings back and forth, the locking block is propelled by the transmission mechanism to reciprocate between a position of clamping the locking disc and a position of releasing the locking disc, so that the locking and unlocking between the head and the supporting seat at any angle are achieved; the locking pin is capable of moving back and forth between a position of inserting into the locking hole and a position of escaping the locking hole through the interaction between the linkage mechanism and the elastic member, so that the automatic locking and unlocking between the head and the supporting seat at a specific angle are achieved.

In another embodiment of the present invention, the locking switch is capable of being switched among a first position, a second position and a third position, wherein the second position is arranged between the first position and the third position. When the locking switch is pressed to the first position, the head and the support seat are in an unlocked state, allowing the head to swing at any angle relative to the support seat. After the locking switch pressed to the first position is released and a user moves the head to a specific angle, the locking pin is capable of automatically inserting into the locking hole directly facing the locking disc under the action of the elastic member. At this point, the head and the support seat are automatically locked at the specific angle. When the locking switch is pressed to the third position, the locking block moves to the position of clamping the locking disc, thereby enabling the head and the support seat to be locked into a whole through the interaction between the locking block and the locking disc.

In another embodiment of the present invention, the transmission mechanism comprises a rotating shaft, a first bevel gear, a second bevel gear and a screw rod, wherein the rotating shaft is rotatably arranged in the head. The first bevel gear is fixedly connected to the rotating shaft. The screw rod is rotatably arranged in the head along the front-rear direction and penetrates through the locking disc. The locking disc is provided with an arc-shaped avoiding groove. The second bevel gear is fixedly connected to the screw rod and is meshed with the first bevel gear for realizing transmission. A front end of the screw rod is in threaded connection with the locking block, and the locking block interacts with the support seat to prevent rotation. When the locking switch swings, the screw rod is propelled to enable the locking block to move between the position of clamping the locking disc and the position of releasing the locking disc, thereby realizing the locking and unlocking between the head and the support seat.

In another embodiment of the present invention, the support seat is provided with a limiting protrusion and a space for allowing the locking block to move back and forth is formed between the limiting protrusion and the locking disc. The locking block is limited by the limiting protrusion such that the locking block is prevented from being separated from the screw rod.

In another embodiment of the present invention, the linkage mechanism comprises a linkage member movably sleeved on the rotating shaft, a first linkage pin fixedly connected to the rotating shaft, and a second linkage pin fixedly connected to a rear end of the locking pin. A first end of the linkage member is provided with a push portion corresponding to the position of the first linkage pin, and a second end of the linkage member maintains a state of abutting against the second linkage pin.

In another embodiment of the present invention, the second linkage pin is transversely arranged in the left-right direction, and the second linkage pin abuts against a rear side of the second end of the linkage member. The linkage member possesses a tendency of forward rotation when the second linkage pin abuts against the linkage member. When the locking switch is pressed to switch to the first position, the first locking pin propels the push portion and the linkage member to rotate backwards, so that the second linkage pin propels the locking pin to move to the position where the locking pin is capable of escaping the locking hole.

In another embodiment of the present invention, when the locking switch is switched from the second position to the first position, the first linkage pin propels the push portion to rotate downwards, so that the linkage member propels the second linkage pin to move away from the locking disc until the locking pin completely escapes the locking hole. When the locking switch pressed to the first position is released, the locking pin moves towards the position of inserting into the locking hole under the elastic force of the elastic member, thereby enabling the second linkage pin to propel the linkage member to reset. At this point, the push portion of the linkage member propels a first linkage member to reset, so that the rotating shaft and the locking switch are reset towards the second position.

In another embodiment of the present invention, a step portion is arranged in the accommodating hole, and an abutting ring is arranged on the locking pin. The elastic member is sleeved on the locking pin, wherein one end of the elastic member abuts against the step portion, and the other end of the elastic member abuts against the abutting ring.

In another embodiment of the present invention, the two ends of the head are respectively fixedly connected to a locking switch for interacting with the transmission mechanism.

In another embodiment of the present invention, the locking disc is provided with a locking position extending upwards from the support seat, and a plurality of locking holes are distributed at intervals along the arc-shaped path at the locking position of the locking disc.

In another embodiment of the present invention, an upper end of the support seat is fixedly connected to a scale plate. The head is provided with a pointer used in conjunction with the scale plate.

Compared with the prior art, the present invention has the following advantages: the same locking switch is used to adjust the head at a specific angle (commonly-used operating angle) or any angle, achieving high versatility, convenient and fast operation, and ideal locking effect.

### BRIEF DESCRIPTION OF THE DRAWINGS

FIG. 1 is a schematic diagram illustrating an exemplary structure of the cutting tool;

FIG. 2 is a schematic diagram illustrating the mounting position of the locking disc of the present invention;

FIG. 3 is a schematic diagram illustrating an exemplary structure of the locking disc of the present invention;

FIG. 4 is a schematic diagram illustrating an exemplary structure of the locking mechanism of the present invention;

FIG. 5 is a schematic diagram illustrating the transmission mechanism and the linkage mechanism of the present invention;

FIG. 6 is a schematic diagram illustrating an exemplary structure after the transmission mechanism and the linkage mechanism are separated;

In Figures: 10—Base, 20—Worktable, 21—Support Seat, 211—Limiting Protrusion, 212—Space, 213—Scale Plate, 30—Cutting Device, 31—Head, 311—Elastic Member, 312—Pointer, 32—Guide Rail Assembly, 33—Cutting Assembly, 40—Locking Mechanism, 41—Locking Disc, 411-Locking Hole, 412—Arc-shaped Avoiding Groove, 42—Locking Block, 43—Locking Pin, 44—Transmission Mechanism, 441—Rotating Shaft, 442—The First Bevel Gear, 443—The Second Bevel Gear, 444—Screw Rod, 45—Linkage Mechanism, 451—Linkage Member, 4511—Push Portion, 452—The First Linkage Pin, 453—The Second Linkage Pin, 46—Locking Switch.

### DETAILED DESCRIPTION

Drawings are combined hereinafter to further elaborate the technical solution of the present invention.

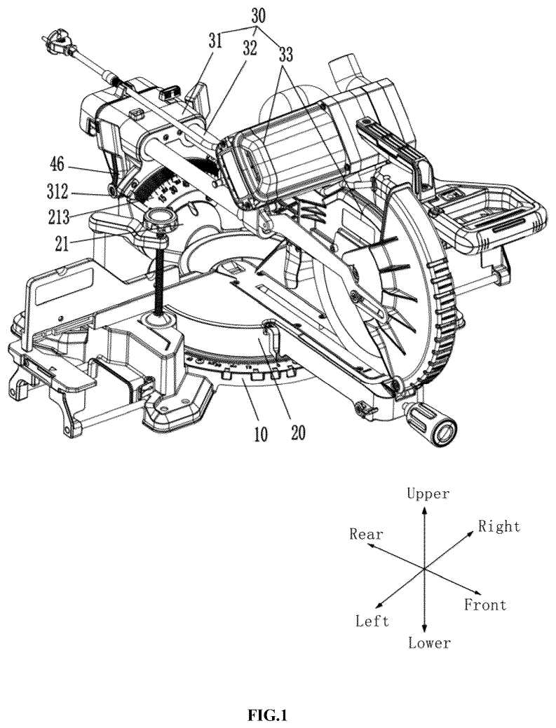

To facilitate the description of the technical solution of the present invention, the upper, lower, front, rear, left, and right directions are also defined as indicated by arrows in FIG. 1. The upper, lower, left, right, front, and rear directions described in the present invention are all based on the position where the cutting tool is located in FIG. 1.

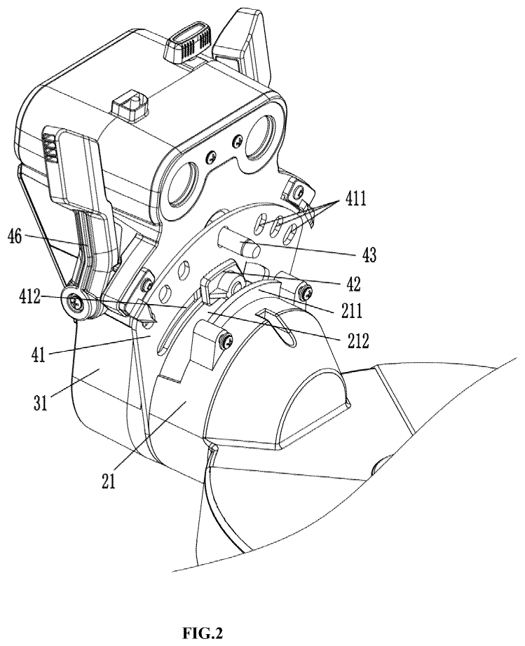

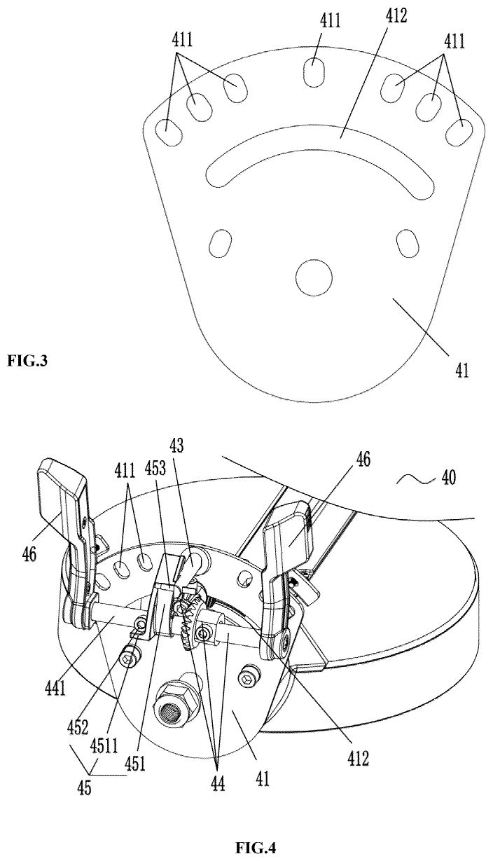

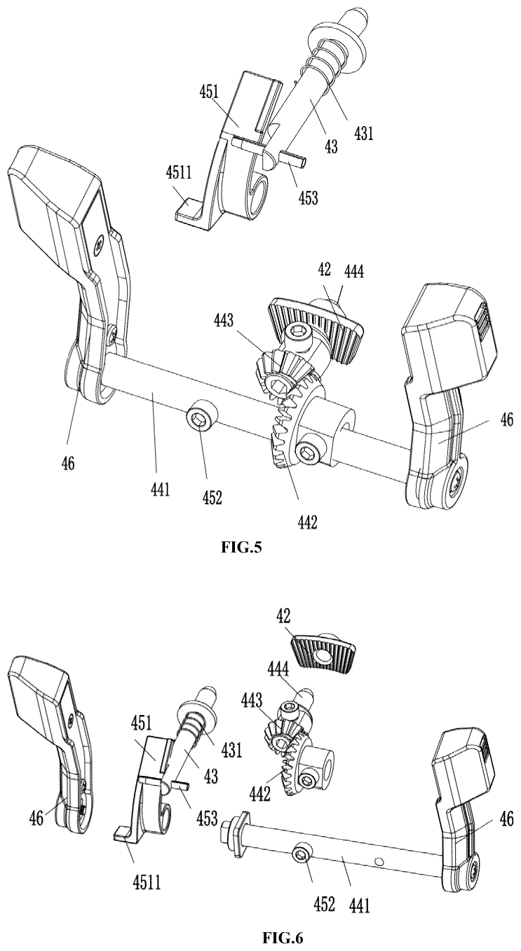

Referring to FIGS. 1-6, a cutting tool, specifically a miter saw, comprises a base 10, a worktable 20 arranged on the base 10, and a cutting device 30 located above the worktable 20. A rear end of the worktable 20 is provided with a support seat 21. The cutting device 30 comprises a head 31 swingably connected to the support seat 21, a guide rail assembly 32 slidably arranged on the head 31, a connecting member connected to a front end of the guide rail assembly 32, and a cutting assembly 33 pivotally connected to the connecting member.

The cutting tool head angle adjustment mechanism comprises the support seat 21 arranged at the rear end of the worktable 20, the head 31 swingably connected to the support seat 21 and a locking disc 41 arranged between the head 31 and the support seat 21. More specifically, the head 31 is rotatably connected to the support seat 21 through a connecting shaft. Namely, the head 31 is capable of swinging left and right along the connecting shaft, which allows the cutting device 30 to swing left and right relative to the worktable 20.

The locking disc 41 is fixedly connected to the support seat 21. The locking disc 41 is also a brake disc. The locking disc 41 is provided with a locking position extending upwards from the support seat 21. More specifically, a front end of the locking disc 41 is attached tot the support seat 21, and a rear end surface of the locking disc 41 is attached to the head 31.

The head angle adjustment mechanism further comprises a locking block 42, a locking pin 43, a transmission mechanism 44, a linkage mechanism 45, and a locking switch 46. One side of the locking block 42 facing the locking disc 41 is provided with locking teeth. By means of the locking teeth, the locking block 42 is clamped with the locking disc 41 such that the locking effect is achieved. The locking disc 41 is provided with a plurality of locking holes 411 arranged at intervals and having a specific angle. The locking holes 411 are arranged in the swinging path of the locking pin 43. The plurality of locking holes 411 are arranged at intervals in an arc shape by taking the connecting shaft as the center. More specifically, the locking holes 411 are all arranged within the swinging range of the locking pin 43, and the included angle between the vertical line and the connecting line formed by the center of the locking holes 411 and the center of the connecting shaft includes but is not limited to −45°, −33.9°, −22.5°, 0°, 22.5°, 33.9° and 45°. Certainly, other specific included angles may be designed according to actual requirements.

The head 31 is internally provided with an accommodating hole for allowing the locking pin 43 to extend and retract. The accommodating hole plays a role in guiding and limiting and is used for ensuring that the locking pin 43 only extends and retracts along the length direction of the accommodating hole. The accommodating hole is internally provided with an elastic member 311 for propelling the locking pin 43 to move in the direction of inserting into the locking hole 411. A rear end of the locking pin 43 is in linkage with the transmission mechanism 44 by means of the linkage mechanism 45. The locking switch 46 is in transmission connection with the locking block 42 by means of the transmission mechanism 44. When the locking switch 46 swings back and forth, the locking block 42 is propelled by the transmission mechanism 44 to reciprocate between a position of clamping the locking disc and a position of releasing the locking disc, so that the locking and unlocking between the head 31 and the supporting seat 21 at any angle are achieved. The locking pin 43 is capable of moving back and forth between a position of inserting into the locking hole and a position of escaping the locking hole through the interaction between the linkage mechanism 45 and the elastic member 311. Thus, the automatic locking and unlocking between the head 31 and the supporting seat 21 at a specific angle are achieved.

The locking switch 46 is capable of being switched among a first position, a second position and a third position, wherein the second position is arranged between the first position and the third position. In this embodiment, the first position is a position where the locking switch 46 swings to a rearmost end, and the third position is a position where the locking switch 46 swings to a foremost end. When the locking switch 46 is pressed to the first position, the head 31 and the support seat 21 are in an unlocked state, allowing the head 31 to swing at any angle relative to the support seat 21. After the locking switch 46 pressed to the first position is released and a user moves the head 31 to a specific angle, the locking pin 43 is capable of automatically inserting into the locking hole 411 directly facing the locking disc 41 under the action of the elastic member 311. At this point, the head 31 and the support seat 21 are automatically locked at the specific angle. When the locking switch 46 is pressed to the third position, the locking block 42 moves to the position of clamping the locking disc, thereby enabling the head 31 and the support seat 21 to be locked into a whole through the interaction between the locking block 42 and the locking disc 41.

By means of operating through the same locking switch 46, the automatic locking between the head 31 and the support seat 21 at a specific angle (a common operating angle) is realized, allowing the head 31 and the support seat 21 to be locked at any position. Thus, high versatility, convenient operation, high locking precision and ideal locking effect are achieved. In use, when there is a need to swing the head 31 of the cutting device 30 to any position (including a particular position at a specific angle or a non-specific angle), the user may press the locking switch 46 to the first position. At this point, the head 31 is in an unlocked state, allowing the user to swing the head to a desired position. Subsequently, when the locking switch 46 is pressed to the third position, the locking block 42 clamps the locking disc 41, so that the head 31 and the support seat 21 are locked into a whole. When the user needs to swing the head 31 of the cutting device 30 to a particular position, only the locking switch 46 needs to be pressed to the first position. At this point, the head 31 of the cutting device 30 is in an unlocked state, and after the locking switch 46 pressed to the first position is released, the user may swing the head 31 to a position near the required specific angle. When the user slightly swings the head 31 by a certain angle until it is right at a specific angle, the locking pin 43 is automatically inserted into the locking hole 411 directly facing the locking pin 43 under the action of the elastic member 311, thereby achieving the automatic locking at the specific angle. To enhance the operating stability of the cutting device 30, after the locking pin 43 is automatically inserted into the locking hole 411, the user may press the locking switch 46 to the third position. In this way, the locking block 42 and the locking disc 41 are locked together such that the stable operation of the cutting device is ensured.

The transmission mechanism 44 includes a rotating shaft 441, a first bevel gear 442, a second bevel gear 443 and a screw rod 444, wherein the rotating shaft 441 is rotatably arranged in the head 31. In this embodiment, the rotating shaft 441 is arranged along the left-right direction, the locking switch 46 is fixedly connected to an end of the rotating shaft 441, and the first bevel gear 442 is fixedly connected to the rotating shaft 441. The screw rod 444 is rotatably arranged in the head 31 along the front-rear direction, and one end of the screw rod 444 penetrates through the locking disc 41. The locking disc 41 is provided with an arc-shaped avoiding groove 412 for allowing the screw rod 444 to swing left and right. The second bevel gear 443 is fixedly connected to the screw rod 444 and is meshed with the first bevel gear 442 for realizing transmission. A front end of the screw rod 444 is in threaded connection with the locking block 42, and the locking block 42 interacts with the support seat 21 to prevent rotation. When the locking switch 46 swings, the screw rod 444 is propelled to enable the locking block 42 to move between the position of clamping the locking disc and the position of releasing the locking disc, thereby locking and unlocking the head 31 and the support seat 21. In the process that the locking switch 46 is pressed to the first position, the rotating shaft 441 propels the screw rod 444 to rotate forward through the first bevel gear 442 and the second bevel gear 443, and the screw rod 444 propels the locking block 42 to move forwards until the locking block 42 moves to the position of releasing the locking disc. At this point, the locking block 42 is separated from the locking disc 41, thereby unlocking the head 31 and the support seat 21. In the process that the locking switch 46 is pressed to the third position, the rotating shaft 441 propels the screw rod 444 to rotate reversely through the first bevel gear 442 and the second bevel gear 443, and the screw rod 444 propels the locking block 42 to move backwards until the locking block 42 moves to the position of clamping the locking disc. At this point, the locking block 42 is locked with the locking disc 41, so that the head 31 and the support seat 21 are locked into a whole.

The support seat 21 is provided with a limiting protrusion 211, and a space 212 for allowing the locking block 42 to move back and forth is formed between the limiting protrusion 211 and the locking disc 41. The locking block 42 is limited by the limiting protrusion 211 such that the locking block 42 is prevented from being separated from the screw rod 444. The space 212 is provided with a limiting rotation stopping surface, a lower end of the locking block 42 abuts against the limiting rotation stopping surface, and the locking block 42 is capable of being prevented from rotating through the limiting rotation stopping surface.

The linkage mechanism 45 comprises a linkage member 451 movably sleeved on the rotating shaft 441, a first linkage pin 452 fixedly connected to the rotating shaft 441, and a second linkage pin 453 fixedly connected to a rear end of the locking pin 43. A first end of the linkage member 451 is provided with a push portion 4511 corresponding to the position of the first linkage pin 452, and a second end of the linkage member 451 maintains a state of abutting against the second linkage pin 453. More specifically, the linkage member 451 is in clearance fit with the rotating shaft 441, so that the linkage member 451 is not propelled to rotate synchronously when the rotating shaft 441 rotates. Only when the rotating shaft 441 propels the first linkage pin 452 to rotate, the linkage member 451 is propelled to rotate by the first linkage pin 452. The second linkage pin 453 is transversely arranged in the left-right direction, and the second linkage pin 453 abuts against a rear side of the second end of the linkage member 451. The linkage member 451 possesses a tendency of forward rotation when the second linkage pin 453 abuts against the linkage member 451. When the locking switch 46 is pressed to switch to the first position, the first locking pin 43 propels the push portion 4511 and the linkage member 451 to rotate backwards, so that the second linkage pin 453 propels the locking pin 43 to move to the position where the locking pin 43 is capable of escaping the locking hole.

When the locking switch 46 is switched from the second position to the first position, the first linkage pin 452 propels the push portion 4511 to rotate downwards, so that the linkage member 451 propels the second linkage pin 453 to move away from the locking disc 41 until the locking pin 43 completely escapes the locking hole 411. When the locking switch 46 pressed to the first position is released, the locking pin 43 moves towards the position of inserting into the locking hole 411 under the elastic force of the elastic member 311, thereby enabling the second linkage pin 453 to propel the linkage member 451 to reset. At this point, the push portion 4511 of the linkage member 451 propels a first linkage member 451 to reset, so that the rotating shaft 441 and the locking switch 46 are reset towards the second position. Namely, no matter which position the locking switch 46 is at, the second linkage pin 453 always abuts against the linkage member 451. When the locking switch 46 is in the third position, the first linkage pin 452 is not in contact with the push portion 4511, and when the locking switch 46 is in the second position, the first linkage pin 452 is not in contact with or just in contact with the push portion 4511. At this point, the locking pin 43 is inserted into the locking hole 411, and when the locking switch 46 is pressed to switch from the second position to the first position, the first linkage pin 452 propels the push portion to rotate downwards, so that the linkage member 451 and the second linkage pin 453 interact to overcome the elastic force of the elastic member 311 to completely pull the locking pin 43 out of the locking hole 411. Because the locking pin 43 is separated from the locking hole 411, the cutting device 30 is in an unlocked state.

A step portion is arranged in the accommodating hole, and an abutting ring is arranged on the locking pin 43. The elastic member 311 is sleeved on the locking pin 43, wherein one end of the elastic member 311 abuts against the step portion, and the other end of the elastic member 311 abuts against the abutting ring. Through the aforesaid arrangement, the locking pin 43 always possesses a tendency of moving towards the position of inserting into the locking hole 411 under the action of the elastic member 311. Two ends of the head 31 are respectively fixedly connected to one locking switch 46 interacting with the transmission mechanism 44. More specifically, the two ends of the head 31 corresponding to the rotating shaft 441 are respectively fixedly connected to one locking switch 46. By means of this arrangement, the user is capable of operating through one of the locking switches 46, so that locking and unlocking of the head 31 is realized and flexible use is facilitated.

The locking disc 41 is provided with a locking position extending upwards from the support seat 21, and a plurality of locking holes 411 are distributed at intervals along the arc-shaped path at the locking position of the locking disc 41.

An upper end of the support seat 21 is fixedly connected to a scale plate 213. In this embodiment, the scale plate 213 is configured to be a shell-shaped structure, which is arranged at an upper end of the support seat 21 for covering the locking disc, locking position, locking pin 43 and locking block 42, etc. The head 31 is provided with a pointer 312 used in conjunction with the scale plate 213. The scale plate 213 helps the user intuitively observe the angle at which the head 31 swings left and right relative to the support seat 21, namely, the angle at which the cutting device 30 swings left and right relative to the worktable 20.

The present invention achieves the following beneficial effects: the same locking switch 46 is used to adjust the head 31 at a specific angle (commonly-used operating angle) or any angle, achieving high versatility, convenient and fast operation, and ideal locking effect.

The above is merely the preferred embodiment of the present invention, and therefore any equivalent changes or modifications made according to the structure, features, and principles described in the scope of the present invention shall fall into the scope defined by the claims of the present invention.

What is claimed is:

1. A cutting tool head angle adjustment mechanism, comprising:
a support seat (21) arranged at the rear end of the worktable (20),
a head (31) swingably connected to the support seat (21), and
a locking disc (41) arranged between the head (31) and the support seat (21), wherein the locking disc (41) is fixedly connected to the support seat (21), wherein the head angle adjustment mechanism further comprises:
a locking block (42), a locking pin (43), a transmission mechanism (44), a linkage mechanism (45), and a locking switch (46), wherein the locking disc (41) is provided with a plurality of locking holes (411) arranged at intervals and having a specific angle, wherein the locking holes (411) are arranged in the swinging path of the locking pin (43), wherein the head (31) is internally provided with an accommodating hole for allowing the locking pin (43) to extend and retract, wherein the accommodating hole is internally provided with an elastic member (311) for propelling the locking pin (43) to move in the direction of inserting into the locking hole (411), wherein a rear end of the locking pin (43) is in linkage with the transmission mechanism (44) by means of the linkage mechanism (45), wherein the locking switch (46) is in transmission connection with the locking block (42) by means of the transmission mechanism (44), wherein when the locking switch (46) swings back and forth, the locking block (42) is propelled by the transmission mechanism (44) to reciprocate between a position of clamping the locking disc and a position of releasing the locking disc, so that the locking and unlocking between the head (31) and the supporting seat (21) at any angle are achieved, and wherein the locking pin (43) is capable of moving back and forth between a position of inserting into the locking hole and a position of escaping the locking hole through the interaction between the linkage mechanism (45) and the elastic member (311), so that the automatic locking and unlocking between the head (31) and the supporting seat (21) at a specific angle are achieved.

2. The cutting tool head angle adjustment mechanism of claim 1, wherein the locking switch (46) is capable of being switched among a first position, a second position and a third position, wherein the second position is arranged between the first position and the third position, wherein when the locking switch (46) is pressed to the first position, the head (31) and the support seat (21) are in an unlocked state, allowing the head (31) to swing at any angle relative to the support seat (21), wherein after the locking switch (46) pressed to the first position is released and a user moves the head (31) to a specific angle, the locking pin (43) is capable of automatically inserting into the locking hole (411) directly facing the locking disc

(41) under the action of the elastic member (311), wherein at this point, the head (31) and the support seat (21) are automatically locked at the specific angle, and wherein when the locking switch (46) is pressed to the third position, the locking block (42) moves to the position of clamping the locking disc, thereby enabling the head (31) and the support seat (21) to be locked into a whole through the interaction between the locking block (42) and the locking disc (41).

3. The cutting tool head angle adjustment mechanism of claim 2, wherein the transmission mechanism (44) comprises:
a rotating shaft (441), a first bevel gear (442), a second bevel gear (443) and a screw rod (444), wherein the rotating shaft (441) is rotatably arranged in the head (31), wherein the first bevel gear (442) is fixedly connected to the rotating shaft (441), wherein the screw rod (444) is rotatably arranged in the head (31) along the front-rear direction and penetrates through the locking disc (41), wherein the locking disc (41) is provided with an arc-shaped avoiding groove (412), wherein the second bevel gear (443) is fixedly connected to the screw rod (444) and is meshed with the first bevel gear (442) for realizing transmission, wherein a front end of the screw rod (444) is in threaded connection with the locking block (42), and the locking block (42) interacts with the support seat (21) to prevent rotation, and wherein when the locking switch (46) swings, the screw rod (444) is propelled to enable the locking block (42) to move between the position of clamping the locking disc (41) and the position of releasing the locking disc (41), thereby realizing the locking and unlocking between the head (31) and the support seat (21).

4. The cutting tool head angle adjustment mechanism of claim 2, wherein
the support seat (21) is provided with a limiting protrusion (211), wherein a space (212) for allowing the locking block (42) to move back and forth is formed between the limiting protrusion (211) and the locking disc (41), and wherein the locking block (42) is limited by the limiting protrusion (211) such that the locking block (42) is prevented from being separated from the screw rod (444).

5. The cutting tool head angle adjustment mechanism of claim 2, wherein the linkage mechanism (45) comprises:
a linkage member (451) movably sleeved on the rotating shaft (441), a first linkage pin

(452) fixedly connected to the rotating shaft (441), and a second linkage pin (453) fixedly connected to a rear end of the locking pin (43), and wherein a first end of the linkage member (451) is provided with a push portion (4511) corresponding to the position of the first linkage pin (452), and a second end of the linkage member (451) maintains a state of abutting against the second linkage pin (453).

6. The cutting tool head angle adjustment mechanism of claim 5, wherein the second linkage pin (453) is transversely arranged in the left-right direction, and the second linkage pin (453) abuts against a rear side of the second end of the linkage member (451), wherein the linkage member (451) possesses a tendency of forward rotation when the second linkage pin (453) abuts against the linkage member (451), and wherein when the locking switch (46) is pressed to switch to the first position, the first locking pin (43) propels the push portion (4511) and the linkage member (451) to rotate backwards, so that the second linkage pin (453) propels the locking pin (43) to move to the position where the locking pin (43) is capable of escaping the locking hole.

7. The cutting tool head angle adjustment mechanism of claim 6, wherein when the locking switch (46) is switched from the second position to the first position, the first linkage pin (452) propels the push portion (4511) to rotate downwards, so that the linkage member (451) propels the second linkage pin (453) to move away from the locking disc (41) until the locking pin (43) completely escapes the locking hole (411), wherein when the locking switch (46) pressed to the first position is released, the locking pin (43) moves towards the position of inserting into the locking hole (411) under the elastic force of the elastic member (311), thereby enabling the second linkage pin (453) to propel the linkage member (451) to reset, and wherein at this point, the push portion (4511) of the linkage member (451) propels a first linkage member (451) to reset, so that the rotating shaft (441) and the locking switch (46) are reset towards the second position.

8. The cutting tool head angle adjustment mechanism of claim 1, wherein the two ends of the head (31) are respectively fixedly connected to a locking switch (46) for interacting with the transmission mechanism

9. (canceled)

10. (canceled)

11. (canceled)

12. (canceled)

13. (canceled)

14. (canceled)

15. The cutting tool head angle adjustment mechanism of claim 1, wherein the locking disc (41) is provided with a locking position extending upwards from the support seat (21), and wherein a plurality of locking holes (411) are distributed at intervals along the arc-shaped path at the locking position of the locking disc (41).

16. (canceled)

17. (canceled)

18. (canceled)

19. (canceled)

20. (canceled)

21. (canceled)

22. The cutting tool head angle adjustment mechanism of claim 1, wherein an upper end of the support seat (21) is fixedly connected to a scale plate (213), and wherein the head (31) is provided with a pointer (312) used in conjunction with the scale plate (213).

23. (canceled)

24. (canceled)

25. (canceled)

26. (canceled)

27. (canceled)

28. (canceled)
